(19) United States
(12) Patent Application Publication
(10) Pub. No.: US 2014/0164159 A1
(43) Pub. Date: Jun. 12, 2014

(54) CUSTOMIZABLE VIRTUAL GIFT WRAPPING & PRESENTATION

(71) Applicant: Christine Lovelace, Bloomington, IN (US)

(72) Inventor: Christine Lovelace, Bloomington, IN (US)

(21) Appl. No.: 13/711,041

(22) Filed: Dec. 11, 2012

(51) Int. Cl. G06Q 30/06

(52) U.S. Cl. CPC G06Q 30/0601
USPC 705/26.1

(57) ABSTRACT

A method of electronic gift giving wherein the presentation of the gift is enhanced through the virtual boxing, wrapping, and delivery of the gift. The presentation of the gift is further enhanced through a virtual unwrapping of the gift that can optionally include animations, puzzles, and having to travel to various locations.

### FIELD

The claimed technology relates generally to online gift giving, and more specifically, to an online virtual wrapping and presentation of gifts.

### BACKGROUND

The concept of wrapping a gift has existed in human culture since the invention of paper. America's gift wrap industry evolved from this early history due in part to the efforts of Joyce C. Hall. In the last century, gift wrapping has become a mainstay in the modern culture of gift giving, irrespective of the holiday or occasion. Gift wrapping and virtual presentation of the gift, which adds a personal touch, imbuing a gift with wonder and curiosity as the contents are unknown at the time of presentation. This overarching expression of time and effort conveys appreciation to the recipient.

Irrespective of the technical advancements of society, individuals will continue to show their generosity, admiration, or appreciation for one another through gift giving. While this constant has developed into an infinitely diverse market for consumers of physical commerce, there has been little or no translation into the virtual world. However, online gift giving can be devoid of a personal touch or emotion. Consumers are generally limited to an email notification with which to present their gift. Furthermore, a simplistic email notification of a gift lacks the luster of unwrapping a tangible gift in person.

What is needed is an online service that provides the emotional connection and personal satisfaction associated with the gift giving and unwrapping experience. This process must also be simplistic and cost effective for the giver while still providing the recipient with the ability to live the traditional experience. The present invention addresses this need.

### BRIEF DESCRIPTION OF THE DRAWINGS

FIG. 1 is a block diagram of an example environment in which an interactive gift wrapping system can be used to virtually wrap a gift.

FIG. 2 details an example block diagram 200 illustrating in one implementation, how a user or gift giver would interact with the gift wrapping system 120 to virtually wrap an electronic gift card, electronic gift certificate, electronic voucher, electronic tickets, message, images, video, data, and the like.

FIG. 3 details an example block diagram illustrating how, in one implementation, a recipient would interact with the gift wrapping system to receive and virtually unwrap an electronic gift box.

FIG. 4 is a block diagram of a computing device capable of implementing a portion or all of the described technology.

### DETAILED DESCRIPTION

Before the present methods, implementations and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an,” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

This application describes a novel, interactive visual and auditory paradigm for implementing virtual gift presentations; enabling users to create or select virtual embodiments of tangible gift boxes, puzzle boxes, game or challenge gift presentation, and other gift decorating and presenting techniques and/or mechanisms. That is, each virtual embodiment of the tangible gift boxes, puzzle boxes, game or challenge gift presentation, and other gift decorating and presenting techniques and/or mechanisms is associated with one or more electronic representations capable of enabling an electronic device to create a representation of the virtual item. For example, a star-shaped virtual gift box can be associated with one or more representations such that the star-shaped virtual gift box can be depicted in a web-browser. In some implementations, the representations are such that the depictions can be rotated and angled to show views of the item at different viewing angles. Further, this technology allows the grantor to generate gift presentations presentable over web enabled devices, email enabled devices, social media enabled devices, and the like. This technology allows users to create, modify, or generate their own gift presentation or to select from numerous preconstructed gift box designs and/or presentations. In some implementations, a virtual giftwrapping department mimicking conventional department store gift wrapping centers is presented to the user.

This technology also provides the user with the ability to quickly scan through the varied gift presentation options by pre-sorting predefined gift presentations based upon user and previous users' selections, inputs, and evaluations. Some implementations also allow for gift box and presentation options to be categorized and pre-sorted by holiday themes, special event themes, significant life events, recipient type, and the like. Some implementations allow evaluations of electronic gift boxes and presentations to be ranked and rated through social media. For example, users can post their favorite gift presentation on social websites where other users can make use of their presentation, suggest enhancements, and evaluate the presentation.

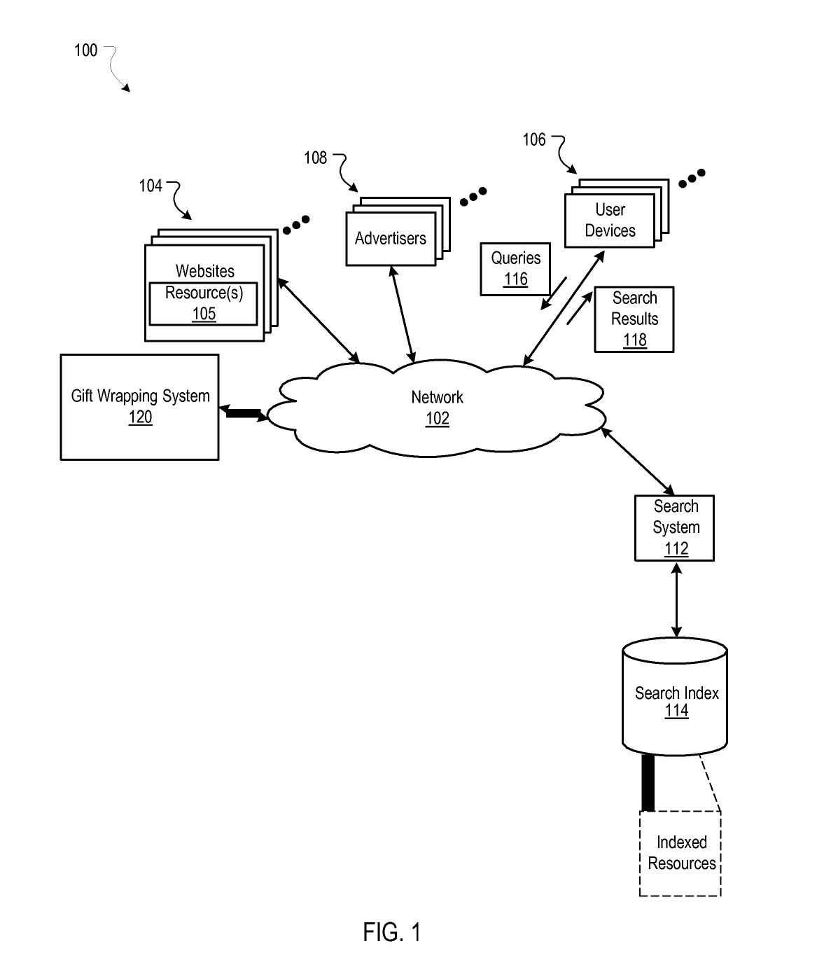

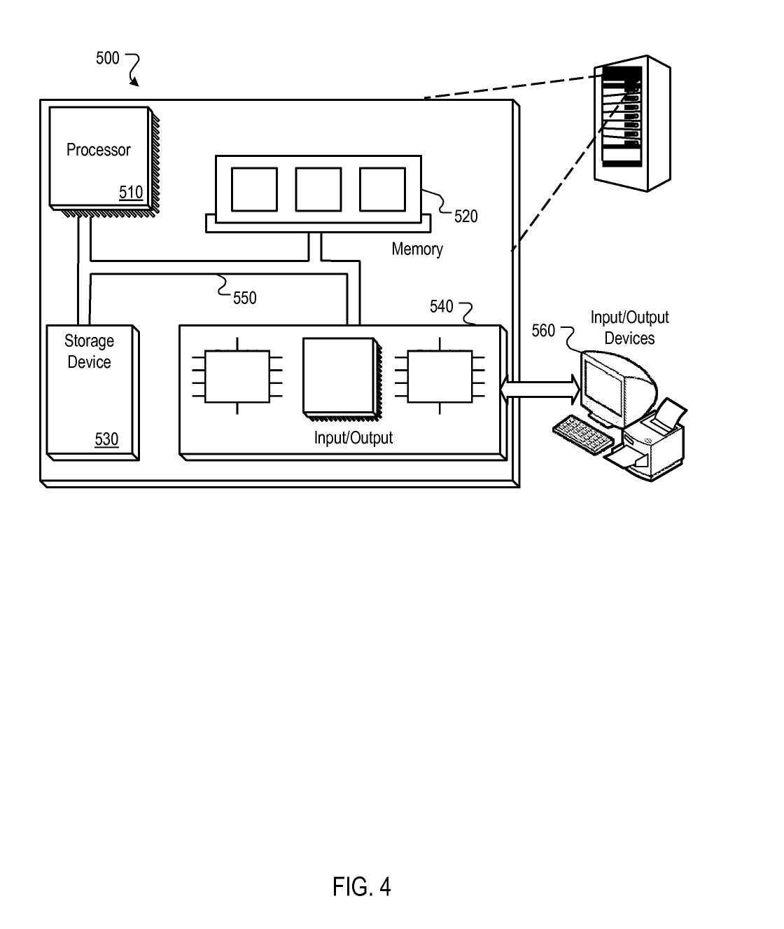

FIGS. 1-4 illustrate an example implementation of a system 100 for providing a system, a method, and software for the claimed novel technology. FIG. 1 is a block diagram of an example environment 100 in which an interactive gift wrapping system 120 can be used to virtually wrap a gift. The example environment 100 includes a network 102, such as a local area network (LAN), a wide area network (WAN), the Internet, or a combination thereof. The network 102 connects websites 104, user devices 106 (also known as personal computing device), content sponsors (e.g. advertisers 108), and a gift wrapping navigation system 120. The example environment 100 may incorporate many thousands of websites 104, user devices 106, and advertisers 108.

A website 104 is one or more resources 105 associated with a domain name and hosted by one or more servers. An example website is a collection of web pages formatted in the hypertext markup language (HTML) that can contain text, images, multimedia content, and programming elements, such as scripts. Each website 104 is maintained by a publisher/sponsor, which is an entity that controls, manages, and/or owns the website 104. A website can also be part of a social media site. An example of such a website is the Facebook™® website.

A resource 105 is any data that can be provided over the network 102. A resource 105 is identified by a resource address that is associated with the resource 105. Resources include HTML pages, word processing documents, and portable document format (PDF) documents, images, video, and feed sources, to name a few. The resources can include content, such as words, phrases, images and sounds, that may include embedded information (such as meta-information in hyperlinks) and/or embedded instructions (such as JavaScript scripts). Units of content that are presented in (or with) resources are referred to as content items.

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display (e.g., a presentation location of a pop-up window or in a slot of a web page) in which advertisements can be presented. These specified portions of the resource or user display are referred to as slots or advertisement slots. These advertisement slots can be used in a variety of schemes with the gift wrapping system 120 such as alerting consumers to the virtual gift wrapping service while they are using the search system 112, alerting a user to the gift wrapping service or related services while the user is shopping on a website 104, or as a to generate additional traffic to other websites related to the user's choices and previous actions. For example, a user reviewing virtual gift wrapping might also receive advertisements in line with the user's review of presentation mechanisms. That is, gag or silly related presentation mechanisms might be associated with advertisements targeted to inexpensive toys and/or gag gifts while more elaborate and traditional gift presentation mechanisms might be associated with advertisements targeting expensive watches, jewelry, and the like. In some implementations, gift presentation mechanisms can also be composed of advertisements (similar to a candy wrapper wrapping a well-known candy). Also, some systems 120 enable users to subsidize the cost of the virtual giftwrapping through the user's interaction of advertisements or selection of advertisement based gift presentations.

To facilitate searching of these resources 105, the environment 100 can include a search system 112 that identifies the resources 105 by crawling and indexing the resources 105 provided by the publishers on the websites 104. In some implementations, the gift wrapping system 120 is able to generate multiple webpages presenting examples of gift wrapping along with content representative of associated user purchases or user advertisement interactions so that examples of gift presentations are able to be crawled and searched in other user's searches. Data about the resources can be indexed based on the resource 105 to which the data corresponds. For example, the gift wrapping system 120 generated examples of gift presentations could be indexed based upon the associated user purchases. The indexed and, optionally, cached copies of the resources 105 are stored in a search index 114.

User devices 106 can submit search queries 116 to the search system 112 over the network 102. In response, the search system 112 accesses the search index 114 to identify resources that are relevant to the search query 116. In the above example, a search for an expensive watch might return images of the watch along with previously used virtual gift presentations for such a watch. Similarly, tickets purchased online for a concert could return images of the band along with band-themed virtual wrapping and presentations. Similarly, tickets for a flight to Paris might return images of Paris along with virtual gift presentations for the trip to Paris. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. An example search result 118 can include a web page title, a snippet of text or a portion of an image extracted from the web page, and the URL of the web page. Search results pages can also include one or more slots in which other content or advertisements can be presented.

When a resource 105 or search results 118 are requested by a user device 106, the advertisement management system 110 receives a request for advertisements to be provided with the resource 105 or search results 118. The request for advertisements can include characteristics of the slots that are defined for the requested resource or search results page, and can be provided to the advertisement management system 110.

For example, a reference (e.g., URL) to the resource for which the slot is defined, a size of the slot, and/or media types that are eligible for presentation in the slot can be provided to the advertisement management system 110. Similarly, keywords associated with a requested resource (“resource keywords”) or a search query 116 for which search results are requested can also be provided to the advertisement management system 110 to facilitate identification of advertisements that are relevant to the resource or search query 116. Continuing with the example, a search query relating to gift watch might return images of a virtually wrapped gift watch as might result from the usage of the gift wrapping system 120 to virtually gift wrap the watch.

Based on data included in a given request, the advertisement management system 110 selects advertisements or other content that is eligible to be provided in response to the request (e.g., eligible advertisements). For example, eligible advertisements can include advertisements having characteristics matching those of slots and that are identified as relevant to specified resource keywords or search queries 116. In some implementations, advertisements that have target keywords that match the resource keywords or the search query 116 are selected as eligible advertisements by the advertisement management system 110.

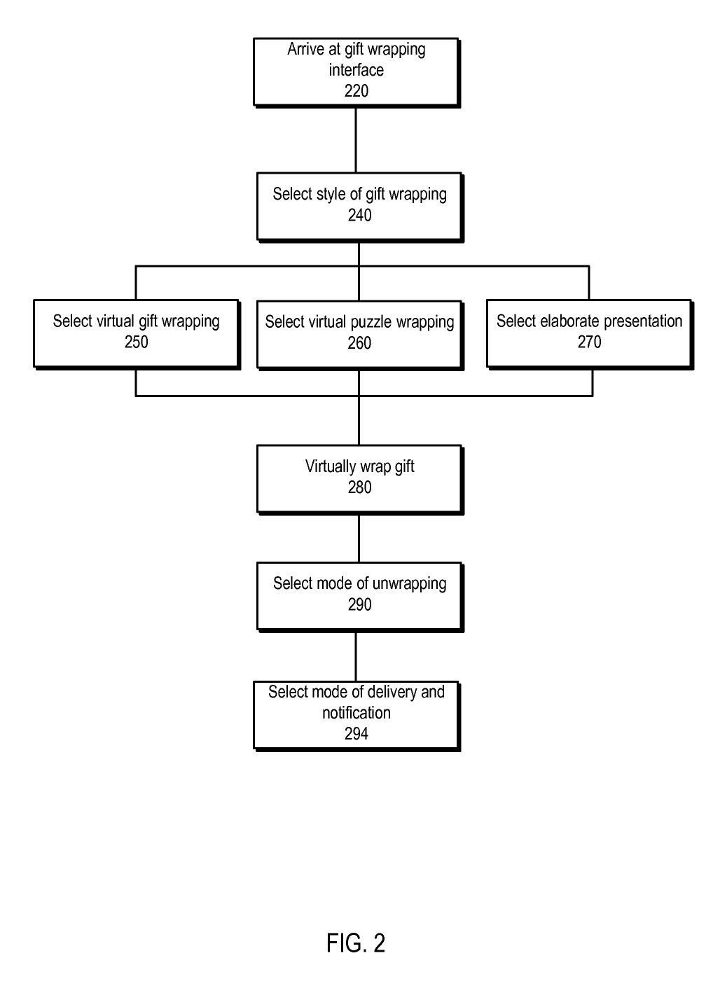

FIG. 2 details an example block diagram 200 illustrating in one implementation, how a user or gift giver would interact with the gift wrapping system 120 to virtually wrap an electronic gift card, electronic voucher, electronic tickets, message, images, video, data, and the like. The virtual gift wrapping experience begins with a user arriving at the gift wrapping interface (220). In some implementations, interaction with the gift wrapping system 120 can be through a web based interface, smart phone based application, a touch screen based interface such as might be found on a commercial kiosk, and the like. In some implementations, a user can arrive at the gift wrapping interface through being redirected to the interface from another interface. For example, a user might arrive at the gift wrapping interface as part of a check out process during the purchase of a good, gift card, electronic ticket, and the like, while on line. Or as another example, a user might arrive at the gift wrapping interface after clicking on a clickable web advertisement. In some implementations, being directed to the gift wrapping interface causes the gift wrapping interface to be pre-populated with virtual gift wrapping and presentation styles in line with the context of the user's current session history. For example, a user after just purchasing a Disney™ type gift can find that the interface is prepopulated with virtual wrappings based upon Disney™ themes. Furthermore, in some implementations, the interface can be prepopulated with virtual wrappings based upon the current month's selection of pre-designed gift boxes and wrappings. For example, during the month of December the user would be presented a pre-populated selection of Christmas or Hanukah themed wrappings.

The user selects the style of virtual gift wrapping (240). In some implementations, the style of virtual gift wrapping can be broken down into three broad categories; a virtual gift wrapping which electronically mimics the experience of a gift wrapped package; a puzzle wrapping which presents the recipient with one or more puzzles which result in the gift being increasingly unwrapped as each puzzle is solved; and an elaborate presentation which can include puzzle solving and other recipient actions such as being at specific locations at specific times. Some implementations also provide for a relaxed version where the recipient only has to arrive at specific locations, but not at any specific time or in any specific location order. In some implementations, elaborate presentation requires the recipient to have a geographical positioning system enabled device such as a smart phone. Alternatively, some implementations can also provide for a keyword phrase or similar mechanism that the recipient can retrieve, presumably when at a specific destination, and enter as part of receiving his gift. Some implementations also provide for an online version where the recipient has to go to various websites instead of actual physical locations. Such implementations can utilize URL tracking, in the case of a smart phone and browser based applications to register the recipient's visitation of the website. Selecting virtual gift wrapping (250) will be covered here while virtual puzzle wrapping (260) and selecting elaborate presentation (270) will be covered in more detail elsewhere.

Upon selecting virtual gift wrapping (250), the user is presented a search and viewing screen. The user can select and virtually wrap the gift (280) from this screen. The user can search for various different virtual box sizes and shapes, different virtual wrappings, different virtual ribbons and bows, different accompanying sounds, and animations that accompany the virtually wrapped gift and play during its unwrapping. Example animations include fireworks, movie and anima clips, a shaking screen effect, and the like. As an example, a gift giver giving a certificate for horse riding lessons could choose a virtual gift box in the shape of a horse, a decorative virtual wrapping having pictures of running horses, and virtual bows that are also in the shape of horses. The gift giver could then choose to have the sounds of a galloping horse play along with animations of running horses play during the recipient's unwrapping of the gift.

More common or standardized box and wrapping combinations can be searched by occasion or recipient. Each common or standardized wrapping combination represents a unique combination of virtual gift-wrap, ribbon, bow, gift tag, and box shape. For example, a gift giver, say a husband away from home on business, could search for the traditional heart shaped red box to virtually wrap an e-gift of chocolates for the giver's wife or lover. Alternatively, a broken heart shaped box could also be used to virtually wrap electronic copies of divorce filings. As still another example, a virtual box of half eaten chocolates along with a note for the recipient to pick out his favorites could be used to virtually wrap an electronic gift certificate to a local chocolate shop.

Some implementations allow the user to design custom virtual gift wrapping by allowing the user to upload pictures. The pictures are then incorporated into a custom wrapping. For example, a couple's wedding pictures could be used to create a custom virtual wrapping for an anniversary gift. Similarly, custom audio recordings can also be incorporated into a custom wrapping. For example, a family could record their singing of Happy Birthday and birthday wishes to incorporate into a custom wrapping of a birthday gift.

Having selected the style of virtual gift wrapping, the user virtually raps the gift (280) and selects the form of recipient notification, recipient gift unwrapping and gift giver (user) notification of receipt, if any. The gift giver can configure the virtually wrapped gift to emulate different unwrapping schemes by selecting the mode of gift unwrapping (290). Some example modes of gift unwrapping include single click to unwrap the entire gift, point and click with each click ripping off more of the virtual gift wrapping and eventually opening the virtual box, drag and drop to manipulate or interact with puzzle wrappings, text and/or speech input, locational input, and the like.

After the configuration of the virtual giftwrapping (electronic gift box) has been determined, the gift giver proceeds to select the mode of delivery and notification (294), if any, of the delivery of the virtually wrapped gift (electronic gift box). Modes of delivery include email delivery where the email is configured to resemble a gift card, holiday card, special event card, and the like such that the email includes a clickable link to the recipient's electronic gift box. In some implementations, the gift giver is given another option of sending the custom finalized electronic gift box through a personal email, push notifications, or a social media website, like Facebook. During this time, the pertinent information such as the receipting's email address, social website account, and the like are obtained. After payment arrangements have been made, the gift wrapping system 120 provides for delivery of the notification. For example, in some implementations the gift wrapping system 120 will interact with the recipient's social website to provide a notification for the recipient.

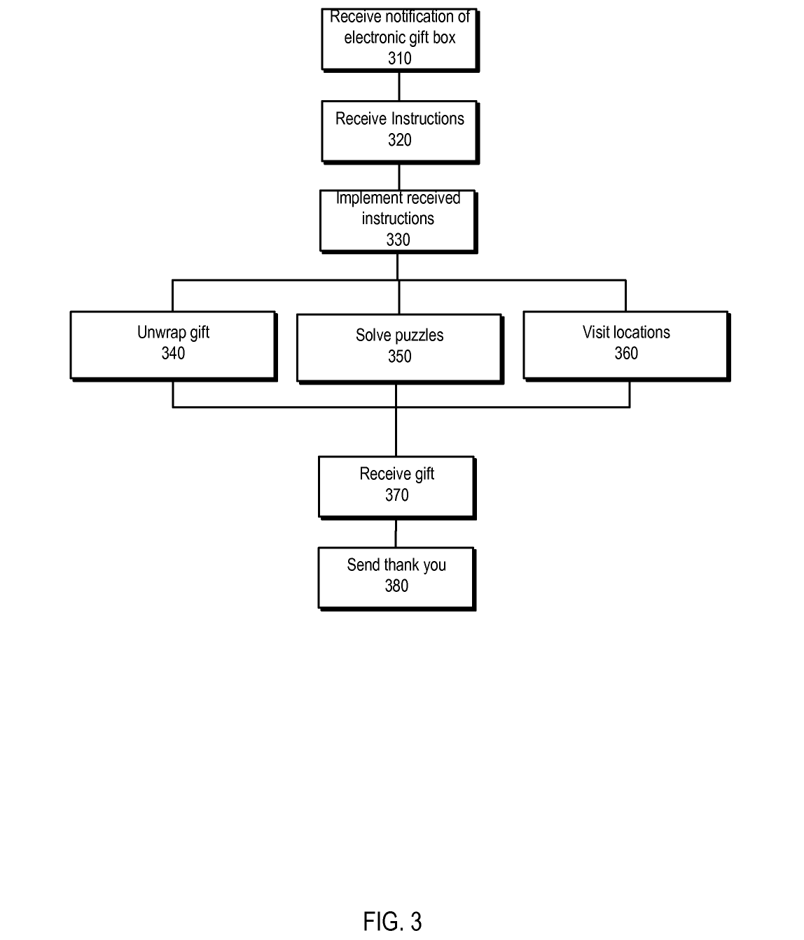

FIG. 3 illustrates a block diagram of a sample implementation for puzzle wrapping (260) and/or selecting elaborate presentation (270) for an electronic gift box. In some implementations, the elements of an elaborate presentation (270) are implemented as elements of a puzzle wrapping (260). The gift giver selects a puzzle wrapping (310). As previously noted puzzle wrappings can take the form of one or more interactive manipulation where the recipient drags and drops or clicks to manipulate puzzle components or enter alpha numeric codes or words. In some implementations, some puzzle components can automatically be solved by extraneous events such as the recipient receiving his electronic gift box through his geographical positioning system enabled smart phone and being at or arriving at a specific location. For example, a puzzle wrapping can take the form of a riddle where there puzzle is solved by the recipient entering in the correct answer. As another example, a puzzle wrapping can take the form of a drag and drop interactive puzzle where the recipient has to pull, by clicking and dragging, the right stick in a pile of sticks to unlock the gift. As still another example, the puzzle can take the form of a quiz where the recipient has to enter in the correct answers before the end of a time period. As yet one more example, the puzzle can take the form of a location where the gift giver enters in a set of coordinates and a riddle whose solution is the location corresponding to the set of coordinates. Typically, such a puzzle also incorporates a backup where the gift giver can provide for the recipient to enter in a phrase or code to also unlock the puzzle. Some implementations also provide for hints or clues to be given to the recipient as the recipient attempts to solve the puzzle.

FIG. 3 details an example block diagram 300 illustrating how, in one implementation, a recipient would interact with the gift wrapping system 120 to receive and virtually unwrap an electronic gift box. The recipient receives notification, via his user device, of his electronic gift box (310) and receives instruction (320) on how to receive his electronic gift box. If the gift giver chose to share the electronic gift box on a social media site than a notification will be presented to the recipient with instructions denoting how to receive his electronic gift box. For example, the instructions may provide a hyperlink that directs the recipient to his electronic gift box. For example, an image of the virtual gift box could be placed upon the wall or public space of the recipient along with a message and a link. Some implementations also provide for the recipient the ability to make the image of the virtual gift to be publically viewable. Alternatively, the recipient can receive an email with instructions stating how the recipient can receive his electronic gift box. In some implementations, the recipient can receive notification of his electronic gift box through an application that runs on his mobile device. For example, the recipient could receive notification of his waiting electronic gift box on his smart phone with the notification taking the form of a text, an email, an automatic call, push notification, and the like.

As elsewhere described, the gift giver's selection of the virtual wrapping and/or presentation of the gift determines the gift opening experience the recipient will experience. For example, the gift giver may have configured an elaborate presentation such that the recipient will have to be at different locations at different times. In such an example, the recipient would receive his gift upon his visit to the final location. An example where such a presentation of a gift might be desirable would be a bachelorette party. The bride-to-be could be made to go to various bachelorette party type locations with the final location being a hangover treatment center. In such an example, the gift itself might be an electronic voucher for the services of the hangover treatment center or a detoxifying treatment center, or a day of pampering at a spa. As another example, the gift giver may have configured a more traditional experience by selecting a virtual gift box and holiday wrapping, possibly with a Christmas style background with colored lights, holiday greenery, and traditional Christmas music.

The recipient implements the received instructions (330) to acquire his gift. In the case of a virtual wrapping, the recipient is instructed to receive the wrapped gift, by clicking on a hyperlink for example, and to unwrap his gift (340). In the case of a puzzle wrapping, the recipient is instructed to receive the wrapped gift, by clicking on a hyperlink for example, and to unwrap his gift through solving one or more puzzles (350). In the case of an elaborate presentation, the recipient is instructed to receive the wrapped gift, by clicking on a hyperlink for example, and to visit one or more locations (360). As stated elsewhere, the locations can be physical or virtual such as websites. Unwrapping the gift (340) and solving the puzzles (350) is performed through utilizing the user device's interfaces to manipulate the virtually wrapped gift or input various information. For example, if on a computer the recipient would utilize the mouse and keyboard to manipulate the virtually wrapped gift or utilize the keyboard to put in alphanumeric solutions to puzzles. In some implementations, a drag and drop mechanism is used to enable the recipient to grab parts of the virtual wrapping of the virtual gift to tear off the gift's wrapping.

Once the electronic gift box is unwrapped, the recipient receives the gift (370). For example, the recipient receives an electronic gift card. As stated elsewhere, the gift giver can configure an animation to play as the gift is obtained. For example, an animation of the gift coming out of the virtual box can be played as the recipient opens his virtual gift box. The recipient can then immediately utilize the gift card or can save the gift card for usage later. At this stage the recipient is provided an option to send a thank you (380). The “thank you” can optionally include recorded sound and/or video. For example, the recipient can upload a video showing how happy he is with his gift. Note, in some implementations, the recipient is optionally given the ability to schedule and send a gift back to the gift giver or to another recipient. For example, the recipient can become a gift giver, including selecting the gift and configuring the virtually wrapping of the gift, and schedule the gift to be sent to the original gift giver or to another recipient.

FIG. 5 is a block diagram of a computing device 500 capable of implementing a portion or all of the described technology. This example portrays a block diagram of a programmable processing system (system) 500 suitable for implementing apparatus or performing methods of various aspects of the subject matter described in this specification. The system 500 includes a processor 510, a random access memory (RAM) 520, a program memory 530 (for example, a writable read-only memory (ROM) such as a flash ROM) and an input/output (I/O) controller 540 (typically endowed with GPS capability) coupled with a bus 550. The system 500 can be preprogrammed, in ROM, for example, or it can be programmed (and reprogrammed) by loading a program from another source (for example, downloaded from an application site, or another computing device).

The I/O controller 540 is operationally connected to I/O interfaces 560. The I/O interface receives and transmits data (e.g., stills, pictures, audio, movies, and animations for importing into a composition) in analog or digital form over communication links such as a serial link, local area network, wireless link, and parallel link, cellular, touch and shake inputs, geographic locational input, and the like.

Embodiments of the subject matter and the operations described in this specification can be implemented as a method, in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method of electronic gift giving comprising:
receiving, by a computer, a selection of a virtual gift box;
receiving, by the computer, a selection of a virtual gift box wrapping such that the virtual gift box is capable of being virtually wrapped with the virtual gift box wrapping;
receiving, by the computer, a selection of an emulation of gift unwrapping;
receiving, by the computer, a selection of an animation;
receiving, by the computer, a selection of a mode of gift delivery.

2. The method of claim 1 wherein receiving a selection of a virtual gift box wrapping further comprises:
receiving, by the computer, an image;
generating, by the computer, the virtual gift wrapping, wherein the virtual gift wrapping incorporates the image.

3. The method of claim 1 wherein receiving a selection of an emulation of gift unwrapping further comprises:
receiving, by the computer, a selection of an elaborate presentation.

4. The method of claim 3 wherein receiving a selection of an elaborate presentation further comprises:
receiving, by the computer, an ordered selection of destinations for a gift recipient to visit.

5. The method of claim 1 wherein receiving a selection of an emulation of gift unwrapping further comprises:
receiving, by the computer, a selection of a puzzle wrapping.

6. The method of claim 5 wherein receiving a selection of a puzzle wrapping further comprises:
receiving, by the computer, a riddle and a set of coordinates, wherein the riddle has a solution equal to a location corresponding to a location designated by the set of coordinates.

7. The method of claim 1 wherein receiving a selection of a mode of gift delivery further comprises:
receiving, by the computer, an identifier of an account of a social website, the account belonging to a recipient of an electronic gift.

8. A system comprising:
a user device;
one or more computers operable to interact with the device;
instructions stored on a machine readable storage device for execution by one or more computers, wherein upon execution of the instructions cause the one or more computers to perform the operations of:
receive a selection of a virtual gift box;
receive a selection of a virtual gift box wrapping such that the virtual gift box is capable of being virtually wrapped with the virtual gift box wrapping;
receive a selection of an emulation of gift unwrapping;
receive a selection of an animation;
receive a selection of a mode of gift delivery.

9. A system of claim 8 wherein the execution of the instructions cause the one or more computers to perform the operations receive a selection of an emulation of gift unwrapping of:
receive an image;
generate the virtual gift wrapping, wherein the virtual gift wrapping incorporates the image.

10. A system of claim 8 wherein the execution the instructions cause the one or more computers to perform the further operations of:
receive an image;
generate the virtual gift wrapping, wherein the virtual gift wrapping incorporates the image.

11. A system of claim 8 wherein the operations of receiving an emulation of gift unwrapping further comprises the operations of:
receive a selection of an elaborate presentation;
receive an ordered selection of destinations for a gift recipient to visit.

12. A system of claim 8 wherein the operations of receiving an emulation of gift unwrapping further comprises the operations of:
receive a selection of a selection of a puzzle wrapping;
receive a riddle and a set of coordinates, wherein the riddle has a solution equal to a location corresponding to a location designated by the set of coordinates.

13. A computer storage medium encoded with a computer program, the program comprising instructions that when executed by a user device cause the user device to perform operations comprising:
receive, by a user device, notification of an electronic gift box;
receive, by the user device, instructions, wherein the instructions instruct how a user can receive the electronic gift box;
receive, through an interface operationally connected to the user device, user manipulations of the electronic gift box;
portray, by the user device, an opening of the electronic gift box;
receive, by the user device, an electronic gift.

14. The computer storage medium encoded with a computer program of claim 13, the program comprising instructions that when executed by a user device cause the user device to perform further operations comprising:
play, by the user device, one or more animations as the electronic gift box is being opened.

15. The computer storage medium encoded with a computer program of claim 13, the program comprising instructions that when executed by a user device cause the user device to perform further operations comprising:
receive, by the user device, a thank-you note response, the thank-you note response sent by the user.

16. The computer storage medium encoded with a computer program of claim 15, the program comprising instructions that when executed by a user device cause the user device to perform further operations comprising:
email the thank-you note to a gift giver.
